(19) United States
(12) Patent Application Publication
(10) Pub. No.: US 2006/0176365 A1
(43) Pub. Date: Aug. 10, 2006

(54) Online alternative dispute resolution process

(76) Inventors: Stanley Lawrence Reisch, Westlake Village, CA (US); Charles Allen Goldman, Sherman Oaks, CA (US); Gary Leonard Reisch, Sherman Oaks, CA (US)

Correspondence Address: Stanley Lawrence Reisch, 181 Little John Court, Westlake Village, CA, 91361, US

(21) Appl. No.: 11/342,148

(22) Filed: Jan. 26, 2006

Related U.S. Application Data
(60) Provisional application No. 60/649,947, filed on Feb. 4, 2005.

(51) Int. Cl. H04N 7/14

(52) U.S. Cl. 348/14.09

(57) ABSTRACT

The present invention features an online system to resolve disputes. The process begins when a client calls to schedule a case. The case manager assigns a case number and sends e-mail to the participants. The parties upload or FAX in their case documents. The mediator and the participants review the case documents before the conference. The mediator and participants log into the videoconferencing program. The mediator introduces parties and provides instructions on how the conference is to be conducted. If there is a technical failure, the case manager will try to resolve the problem or reschedule the conference. The mediator hears the case and uses the online case file system, to guide the participants to an amicable resolution. If there is not settlement, the parties may agree to arbitrate. The parties may agree upon binding or non-binding arbitration. If the case is resolved, the mediator or arbitrator confirms a settlement and the case manager notifies accounting to bill the parties.

### RELATED APPLICATION

The present application is a continuation application of the United States provisional patent application, application No. 60/649,947, filed Feb. 4, 2005, for ONLINE ALTERNATIVE DISPUTE RESOLUTION PROCESS, by Stanley Lawrence Reisch, Charles Allen Goldman and Gary Leonard Reisch, included by reference herein and for which benefit of the priority date is hereby claimed.

### FIELD OF THE INVENTION

The present invention relates to an online alternative dispute resolution process, and more particularly, a process which emulates and provides the characteristics of a conventional face-to-face mediation or arbitration conference between two or more parties using an Internet connection, personal computers, a videoconferencing program and a case management system which can be used by attorneys, lawyers, other legal professionals, courts, individuals and government entities in order to carry on negotiations, mediations, arbitrations, depositions, settlement conferences or any other appropriate application of the process.

### BACKGROUND OF THE INVENTION

With the rapidly increasing number of civil legal cases going to court, almost every state legislature and court system is introducing and implementing procedures for the use of the Alternative Dispute Resolution (ADR) Process, in order to reduce the growing case load. In many states, programs have been introduced that now mandate the use of ADR including negotiation, mediation and arbitration to resolve disputes in civil cases.

The use of online videoconferencing offers participants in the Alternative Dispute Resolution (ADR) Process a way save time, save travel and reduce costs as compared with time consuming and more expensive conventional face-to-face mediation or arbitration conferences. Along with a sophisticated and state-of-the-art videoconferencing program, the process includes a extensive case handling system which makes it easy for conference participants to enter and view printed and visual evidence, as well as, other documents pertinent to the case being mediated or arbitrated. The process is also appropriate for depositions, settlement conferences and many other legal processes.

It is therefore an object of the invention to provide an online alternative dispute resolution process.

It is another object of the invention to provide a process, which emulates and provides the characteristics of a conventional face-to-face mediation or arbitration conference.

It is another object of the invention to provide a conference for two or more parties.

It is another object of the invention to provide a conference using an Internet connection, personal computers, a videoconferencing program and a case management system.

It is another object of the invention to provide a service, which can be used by attorneys, lawyers, other legal professionals, courts, individuals and government entities.

It is another object of the invention to provide a service, which will allow the participants to carry on negotiations, mediations, arbitrations, depositions, settlement conferences or any other appropriate application of the process.

It is therefore an advantage of the invention to provide an online alternative dispute resolution process.

It is another advantage of the invention to provide a process, which emulates and provides the characteristics of a conventional face-to-face mediation or arbitration conference.

It is another advantage of the invention to provide a conference for two or more parties.

It is another advantage of the invention to provide a conference using an Internet connection, personal computers, a videoconferencing program and a case management system.

It is another advantage of the invention to provide a service, which can be used by attorneys, lawyers, other legal professionals, courts, individuals and government entities.

It is another advantage of the invention to provide a service, which will allow the participants to carry on negotiations, mediations, arbitrations, depositions, settlement conferences or any other appropriate application of the process.

### SUMMARY OF THE INVENTION

In accordance with the present invention, there is provided an online alternative dispute resolution process, and more particularly, a process which emulates and provides the characteristics of a conventional face-to-face mediation or arbitration conference between two or more parties using an Internet connection, personal computers, a videoconferencing program and a case management system which can be used by attorneys, lawyers, other legal professionals, courts, individuals and government entities in order to carry on negotiations, mediations, arbitrations, depositions, settlement conferences or any other appropriate application of the process.

The process begins when a client calls in to schedule a case. The case manager sets up the case by assigning a case number and then sends an e-mail to the participants. The parties upload or FAX in their case documents to the server. The mediator and the participants review the case documents at least 24 hours before the conference is scheduled to begin.

The mediator logs into the videoconferencing program and sets up the virtual conference room. The participants log into the videoconferencing program at a designated time. The conference begins with the introduction of the parties by the mediator who then provides instructions on how the conference is to be conducted. Should there be a technical failure the mediator will contact the case manager who will then try to resolve the problem so the conference can continue or reschedule the conference for a later date. The mediator hears the case and uses the online case file system to refer to case documents, as necessary, to guide the participants to an amicable resolution. If the case is not resolved through mediation, the case manager follows up with mediator to confirm that there was no settlement.

The parties may agree to arbitrate. The case is rescheduled and continues at designated time. The parties may agree upon binding or non-binding arbitration. If the case is resolved, the case manager follows up with mediator or arbitrator to confirm settlement. The case manager notifies the accounting department to bill the parties.

### BREIF DESCRIPTION OF THE DRAWINGS

A complete understanding of the present invention may be obtained by reference to the accompanying drawings, when considered in conjunction with the subsequent, detailed description, in which:

FIG. 1 is a flow chart view of an online dispute resolution process, which includes 1a and 1b, when taken together represent the entire process.

For purposes of clarity and brevity, like elements and components will bear the same designations and numbering throughout the FIGURES.

### DESCRIPTION OF THE PREFERRED EMBODIMENT

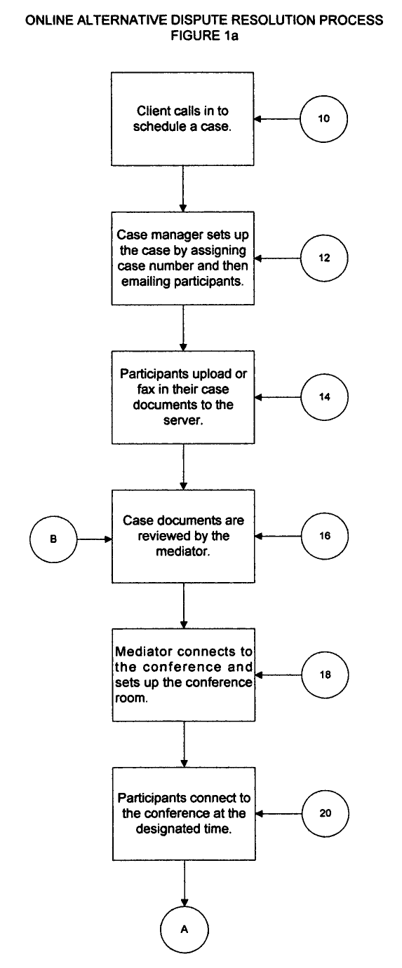

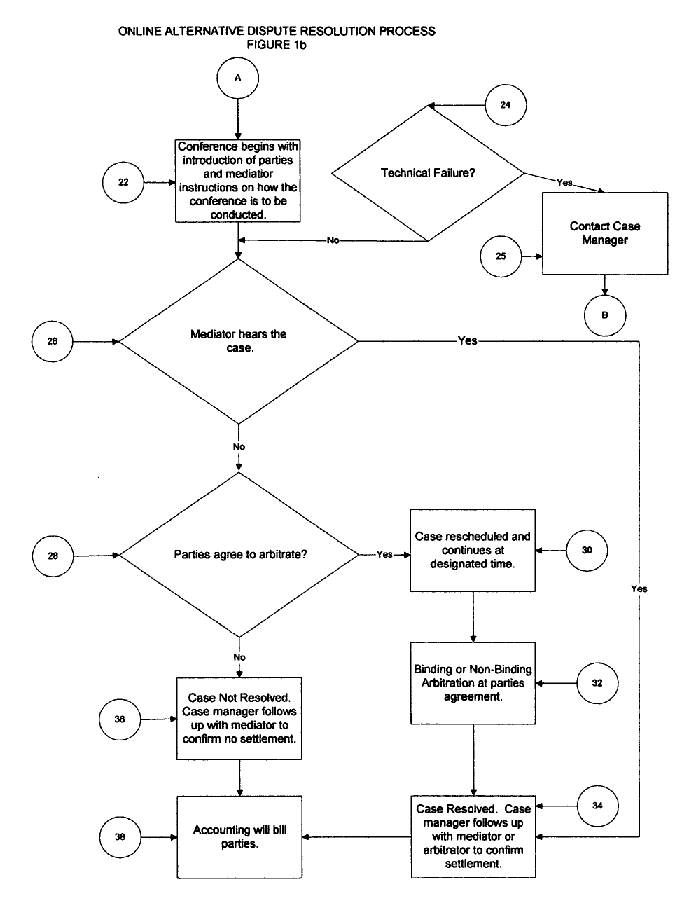

FIGS. 1a and 1b, taken together, is a flow chart, which illustrates the steps of the online alternative dispute resolution process. The process begins when a client calls in to schedule a case using the videoconferencing service (step 10). Then case manager sets up the case by assigning a case number and then sends an e-mail to the participants (step 12). The participants then upload or FAX in their case documents to the server (step 14). The mediator and participants then review the case documents at least 24 hours before the conference is scheduled to begin (step 16). The mediator then logs into the videoconferencing program and sets up the virtual conference room (step 18).

The participants then log into the videoconferencing program at a designated time (step 20). The conference then begins with the introduction of the participants by the mediator who then provides instructions on how the conference is to be conducted (step 22). Should there be a technical failure (step 24), the mediator will contact the case manager (step 25), who will then try to resolve the problem so the conference can continue or reschedule the conference for a later date. The mediator then hears the case and uses the online case file system to refer to case documents, as necessary, to guide the participants to an amicable resolution (step 26). If no amicable resolution is reached, the parties may agree to arbitrate (step 28). The case is then rescheduled and continues at a designated time (step 30). There may be a binding or non-binding arbitration at the parties agreement (step 32). If the case is resolved the case manager follows up with the mediator or arbitrator to confirm the settlement (step 34). If the case is not resolved and the case manager follows up with the mediator to confirm that there is no settlement (step 36). The case manager then notifies the accounting department to bill the parties (step 38).

The client calls in to schedule a case using the videoconferencing service (step 10).

The case manager sets up the case by assigning a case number and then sends an e-mail to the participants (step 12).

The parties upload or FAX in their case documents to the server (step 14).

The case documents are reviewed by the mediator and participants at least 24 hours before the conference is scheduled to begin (step 16).

The mediator logs into the videoconferencing program and sets up the virtual conference room (step 18).

The participants log into the videoconferencing program at a designated time (step 20).

The conference begins with the introduction of the parties by the mediator who then provides instructions on how the conference is to be conducted (step 22).

If there should be a technical failure (step 24), the mediator will contact the case manager (step 25), who will then try to resolve the problem so the conference can continue or reschedule the conference for a later date.

The mediator hears the case and uses the online case file system to refer to case documents, as necessary, to guide the participants to an amicable resolution (step 26).

If there is no amicable resolution, the parties may agree to arbitrate (step 28).

The case is then rescheduled and continues at designated time (step 30).

The parties may agree to binding or non-binding arbitration (step 32).

If the case is resolved, the case manager follows up with mediator or arbitrator to confirm settlement (step 34).

If the case not resolved, the case manager follows up with mediator to confirm no settlement (step 36).

The case manager notifies the accounting department to bill the parties (step 38).

In operation, the client first calls or communicates with ADR case management to schedule a case. Then a case manager sets up the case by assigning a case number an then sends an e-mail to the participants. Then the participants upload or FAX in their case documents to the server. Then the case documents are reviewed by the mediator and participants at least 24 hours before the conference is scheduled to begin. Then the mediator logs into the videoconferencing program and sets up the virtual conference room. Then the participants log into the videoconferencing program at a designated time. Next the conference begins with the introduction of the participants by the mediator who then provides instructions on how the conference is to be conducted. Should there be a technical failure the mediator will contact the case manager who will then try to resolve the problem so the conference can continue or reschedule the conference for a later date. Then the mediator hears the case and uses the online case file system to refer to case documents, as necessary, to guide the participants to an amicable resolution. If the case is resolved the case manager follows up with the mediator to confirm the settlement. If the case is not resolved, the parties can agree go to arbitration. Then the mediator will contact the case manager to schedule a continuation of the conference at a later date. Next, the parties take part in a binding or non-binding arbitration. The case is resolved and the case manager will follow up with the arbitrator to confirm the settlement. At the conclusion of the conference the case manager will notify the accounting department to bill the participants for the cost of the services rendered.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method for resolving a dispute between or among parties with the use of an online communications network, the steps comprising:
a) uploading at least one case document to an online case file system residing on a server;
b) providing a videoconferencing program; and
c) conducting an online conference at a predetermined time among the parties in dispute and a mediator for guiding said parties in discussing and resolving a dispute.

2. The method for resolving disputes between or among parties in accordance with claim 1, wherein said uploading step (a) comprises uploading by performing at least one of the steps: e-mailing and faxing.

3. The method for resolving disputes between or among parties in accordance with claim 1, wherein said providing a videoconferencing program step (b) comprises establishing a videoconferencing room.

4. The method for resolving disputes between or among parties in accordance with claim 1, wherein said conducting a conference step (c) further comprises using said online case file system to refer to case documents.

5. The method for resolving disputes between or among parties in accordance with claim 1, the steps further comprising:
d) scheduling another conference among said parties and said mediator if no amicable resolution is reached.

6. The method for resolving disputes between or among parties in accordance with claim 1, further comprising:
d) billing said parties for services rendered thereto.

7. The method for resolving disputes between or among parties in accordance with claim 1, wherein said conducting a conference step (c) further comprises:
d) agreeing to arbitrate said dispute if no amicable resolution is reached.

8. The method for resolving disputes between or among parties in accordance with claim 1, wherein said conducting a conference step (c) comprises using at least one of the group: videoconferencing, telephoning, and e-mailing.

9. A method for resolving a dispute between or among parties with the use of an online communications network, the steps comprising:
a) uploading at least one case document to an online case file system residing on a server; and
b) conducting an online conference at a predetermined time among the parties in dispute and a mediator for guiding said parties in discussing and resolving a dispute.

10. The method for resolving disputes between or among parties in accordance with claim 9, wherein said uploading step (a) comprises uploading by performing at least one of the steps: e-mailing and faxing.

11. The method for resolving disputes between or among parties in accordance with claim 9, wherein said conducting a conference step (b) further comprises using said online case file system to refer to case documents.

12. The method for resolving disputes between or among parties in accordance with claim 9, the steps further comprising:
c) scheduling another conference among said parties and said mediator if no amicable resolution is reached.

13. The method for resolving disputes between or among parties in accordance with claim 9, further comprising:
c) billing said parties for services rendered thereto.

14. The method for resolving disputes between or among parties in accordance with claim 9, wherein said conducting a conference step (b) further comprises:
c) agreeing to arbitrate said dispute if no amicable resolution is reached.

15. The method for resolving disputes between or among parties in accordance with claim 9, wherein said conducting a conference step (b) comprises using at least one of the group: videoconferencing, telephoning, and e-mailing.
